(19) United States
(12) Patent Application Publication
(10) Pub. No.: US 2026/0278999 A1
(43) Pub. Date: Sep. 17, 2026

(54) SYSTEM AND METHOD FOR CYCLE TIME DETECTION

(71) Applicants: Inventec (Pudong) Technology Corporation, Shanghai (CN); INVENTEC CORPORATION, TAIPEI CITY (TW)

(72) Inventors: Yu-Chi LIAO, TAIPEI CITY (TW); YuLun CHANG, TAIPEI CITY (TW); Wei-Chao CHEN, TAIPEI CITY (TW)

(21) Appl. No.: 19/275,971

(22) Filed: Jul. 21, 2025

(30) Foreign Application Priority Data
Mar. 13, 2025 (CN) 202510299334.1

(51) Int. Cl. G06V 10/40; G06V 10/762

(52) U.S. Cl. CPC G06V 10/40; G06V 10/762

(57) ABSTRACT

A system for cycle time detection is provided. The system comprises a camera device and an electronic device. The camera device captures a video of a workstation. The electronic device comprises a storage device and a processor. The storage device stores a machine learning model. The processor is configured to: perform an inference of the machine learning model to generate first feature vectors corresponding to first time points in the video separately; perform a cluster analysis to the first feature vectors to generate first centroids, and classify each one of the first feature vectors into a corresponding one of clusters, in which the clusters correspond to the first centroids separately; and generate cycle times according to second time points of second feature vectors that are classified into a representative cluster, in which the second feature vectors are among the first feature vectors.

### CROSS-REFERENCE TO RELATED APPLICATION

This application claims priority to China Application Serial Number 202510299334.1 filed Mar. 13, 2025, which is herein incorporated by reference.

### BACKGROUND

### Field of Disclosure

The present disclosure relates to system and method for cycle time detection, and more particularly, system and method for cycle time detection based on video data.

### Description of Related Art

Cycle time is defined as the time cost of specific steps within a production process. In practical applications, supervisors usually calculate the average cycle time by dividing the total time period by the number of times the specific steps is performed during that period. Cycle time is a key performance indicator for measuring production line efficiency. Supervisors can use cycle time to determine whether there are abnormalities in the production line or if there is potential for improving efficiency.

### SUMMARY

An aspect of the present disclosure is to provide a system for cycle time detection. The system comprises a camera device and an electronic device. The camera device captures a video of a workstation. The electronic device comprises a storage device and a processor. The storage device stores a machine learning model. The processor is configured to: perform an inference of the machine learning model to generate first feature vectors corresponding to first time points in the video separately; perform a cluster analysis to the first feature vectors to generate first centroids, and classify each one of the first feature vectors into a corresponding one of clusters, in which the clusters correspond to the first centroids separately; and generate cycle times according to second time points of second feature vectors that are classified into a representative cluster, in which the second feature vectors are among the first feature vectors.

In some embodiments, the processor determines whether the first time points correspond to a break time of the workstation according to a standard deviation of the first centroids, in which the first time points are determined to correspond to the break time, the processor stops generating the cycle times.

In some embodiments, the processor adjusts the first centroids according to second centroids and a weight stored in the storage device.

In some embodiments, the processor increases a value of the weight over time.

In some embodiments, the processor decreases the value of the weight when the first time points are determined as a break time.

Another aspect of the present disclosure is to provide a method for cycle time detection, which includes the following steps: generating a video corresponding to a workstation through a camera; generating a plurality of feature vectors of the video through a neural network, wherein each one of the feature vectors corresponds to a time point; performing a cluster analysis to the feature vectors through a processor to generate multiple centroids, and classifying each one of the feature vectors into a corresponding one of a plurality of clusters, wherein the clusters correspond to the centroids separately; determining one of the clusters as a representative cluster, and when a first feature vector in the feature vectors is classified into the representative cluster, determining the time point corresponding to the first feature vector as a first time point through the processor; and when a second feature vector in the feature vectors is classified into the representative cluster, determining the time point corresponding to the second feature vector as a second time point, and determining a cycle time of the workstation according to an interval between the first time point and the second time point through the processor.

In some embodiments, the method further comprises: determining whether the time points belong to a break time of the workstation according to whether a standard deviation of the centroids is smaller than a threshold.

In some embodiments, the method further comprises: generating multiplications between a plurality of historical centroids and a weight; and updating the centroids according to a plurality of additions between the multiplications and the centroids.

In some embodiments, the method further comprises: decreasing a value of the weight when the time points are determined belonging to a break time.

In some embodiments, the method further comprises: stopping decreasing the value of the weight when the value of the weight is one.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a system for detecting cycle time, in accordance with various embodiments of the present disclosure.

FIG. 2 is a schematic diagram of a system configured with respect to the system of FIG. 1, in accordance with various embodiments of the present disclosure.

FIG. 3 is a flowchart of a method, in accordance with some embodiments of the present disclosure.

FIG. 4 depicts an example of generation of the feature vector, in accordance with various embodiments of the present disclosure.

FIG. 5 depicts an example of length and distribution of cycle time, in accordance with various embodiments of the present disclosure.

FIG. 6 depicts an example of length and distribution of cycle time, in accordance with various embodiments of the present disclosure.

### DETAILED DESCRIPTION

The spirit of the present disclosure will be clearly explained in the following drawings and detailed descriptions. Anyone with ordinary knowledge in the art, after understanding the preferred embodiments of the present disclosure, can make changes and modifications based on the techniques taught in the present disclosure. It does not depart from the spirit and scope of this disclosure. Wherever possible, the same reference numbers are used in the drawings and the description to refer to the same or like parts. Well-known implementations or operations are not shown or described in detail to avoid obscuring aspects of various embodiments of the present disclosure.

It should be noted that terms used herein to describe various components or procedures, such as “first” and “second”, are intended to distinguish one component or procedure from another. However, elements, procedures and their sequence should not be limited by these terms. For example, a first element could be termed a second element, and a second element could, similarly, be termed a first element, without departing from the scope of the present disclosure.

The present disclosure provides system and method for detecting cycle time. Cycle time is a common metric in manufacturing. An excessively long cycle time may indicate that there are abnormalities in the production line or operations within the process that need improvement. Therefore, monitoring the cycle time of the production line is an important task.

In some highly automated factories, cycle time can be obtained directly from the records of process machines. However, in production lines with a wide variety of products, the level of automation may be lower, and more manual workstations exist. These manual workstations become a challenge for cycle time detection.

In some embodiments, a workstation may be an operational area for assembly, adjustment, testing, or other operations on a product or a semi-finished product. At this workstation, a set of operations may be performed periodically, and the time taken to perform this set of operations once can be regarded as a cycle time. The set of operations may include multiple actions. In some embodiments, when a representative action within these actions is performed twice, it can be considered that one cycle has been completed. The time interval between two representative actions that are adjacent in time can be regarded as one cycle time.

The cycle time detection system and method provided in this disclosure can achieve cycle time detection for manual workstations. Some embodiments of the system and method implement real-time cycle time detection and preliminary abnormality determination based on video generated by a camera device focused on the workstation.

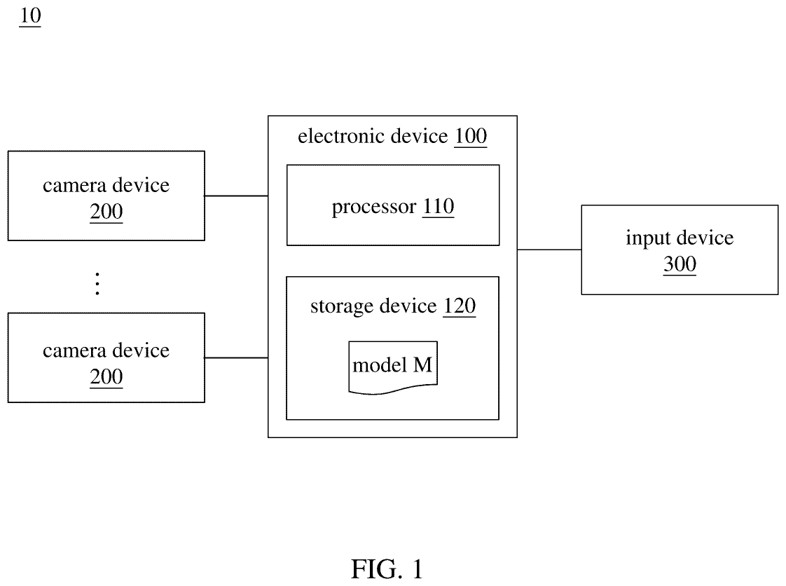

Reference is now made to FIG. 1. FIG. 1 is a schematic diagram of a system 10 for detecting cycle time, in accordance with various embodiments of the present disclosure. For illustration, the system 10 includes an electronic device 100, one or more camera device 200 and an input device 300. The electronic device 100 is coupled to the camera device 200 and the input device 300. It should be understood that, in the scope of the embodiments of the present disclosure, the description of “coupling” may generally refer to the indirect electrical coupling of one element to another element through other elements, or the direct electrical coupling of an element without passing through other elements.

In some embodiments, the electronic device 100 is a device with computing capabilities, such as a computer, a mobile device and so on. The electronic device 100 includes a processor 110 and a storage device 120.

In some embodiments, the processor 110 is a central processing unit (CPU), or other programmable general-purpose or special-purpose micro control units (MCU), microprocessors, digital signal processors (DSP), programmable controllers, application-specific integrated circuits (ASIC), graphics processing units (GPU), arithmetic logic units (ALU), complex programmable logic devices (CPLD), field-programmable gate arrays (FPGA), or other similar components or a combination of the above components.

In some embodiments, the storage device 120 is a static random access memory (SRAM), a dynamic random access memory (DRAM), a disk, other data storage devices or a combination of the above components.

In some embodiments, the camera device 200 is a device for capturing video, e.g., a video camera. In some embodiments, the input device 300 is a keyboard, a mouse, a touch screen, a button, any similar components or a combination of the above components.

In operation, the camera device 200 takes a video of the workstation, and the electronic device 100 receives the video from the camera device 200.

After the electronic device 100 receives the video, the processor 110 executes an inference operation of a model M with the video provided as input to the model M to perform a cycle time detection of the workstation.

In some embodiments, the model M is an artificial intelligence model, for example, a machine learning model including neural network. In some embodiments, the model M can be implemented by one or more of the followings: convolution neural network (CNN), dense neural network (DNN) or any other neural network.

In some embodiments, the input device 300 generates a control signal according to user input. The processor 110 determines the target workstation of the cycle time detection and a region of interest (ROI) in the video according to the control signal. The ROI is the area in the video targeted for the cycle time detection. Specifically, in some embodiments, the processor 110 only uses the ROI in the video as the input to the model M to perform the inference of the model M.

In some embodiments, the storage device 120 is used to store one of more of the followings: the video from the camera device 200, the model M, the workstation targeted for the cycle time detection and the ROI in the video.

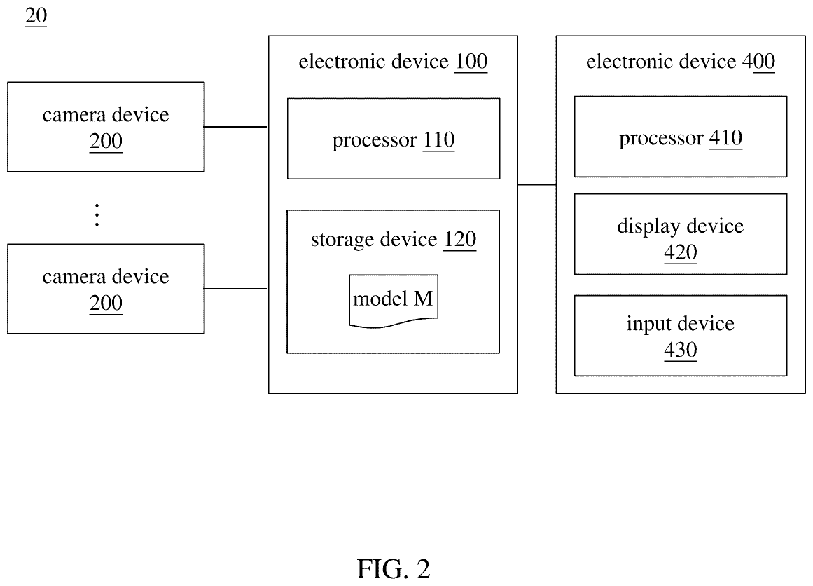

Reference is now made to FIG. 2. FIG. 2 is a schematic diagram of a system 20 configured with respect to the system 10 of FIG. 1, in accordance with various embodiments of the present disclosure. The specific operations of similar elements, which are already discussed in detail previously, are omitted for the sake of brevity.

The system 20 is similar to the system 10. The difference between the systems 10 and 20 is that the system 20 further includes an electronic device 400. In some embodiments, the electronic device 400 is a terminal device. As shown in FIG. 2, in some embodiments, the electronic device 400 includes a processor 410, a display device 420 and an input device 430.

According to some embodiments, the processor 410 is a component similar to the processor 110. The input device 430 is a component similar to the input device 300. The display device 420 is a device for displaying images, e.g., a monitor.

In some embodiments, the processor 410 controls the display device 420 to display a user interface.

In some embodiments, when the display device 420 displays the user interface, the input device 430 is used to adjust the setting of the cycle time detection according to user input, for example, adjusting the ROI described above.

In some embodiments, the processor 110 generates a chart or table according to a result of the cycle time detection. The storage device 120 stores the result and the chart or table of the cycle time detection.

In some embodiments, the display device 420 displays the result and the chart or table of the cycle time detection in the user interface for the user to examine.

The configurations of FIG. 1 and FIG. 2 are given for illustrative purposes. Various implements are within the contemplated scope of the present disclosure. For example, the coupling shown in FIGS. 1-2 can be replaced by signal connection such as wired network connection, wireless network connection, or optical transmission. For example, the camera device 200 is connected to the electronic device 100 through a wireless network.

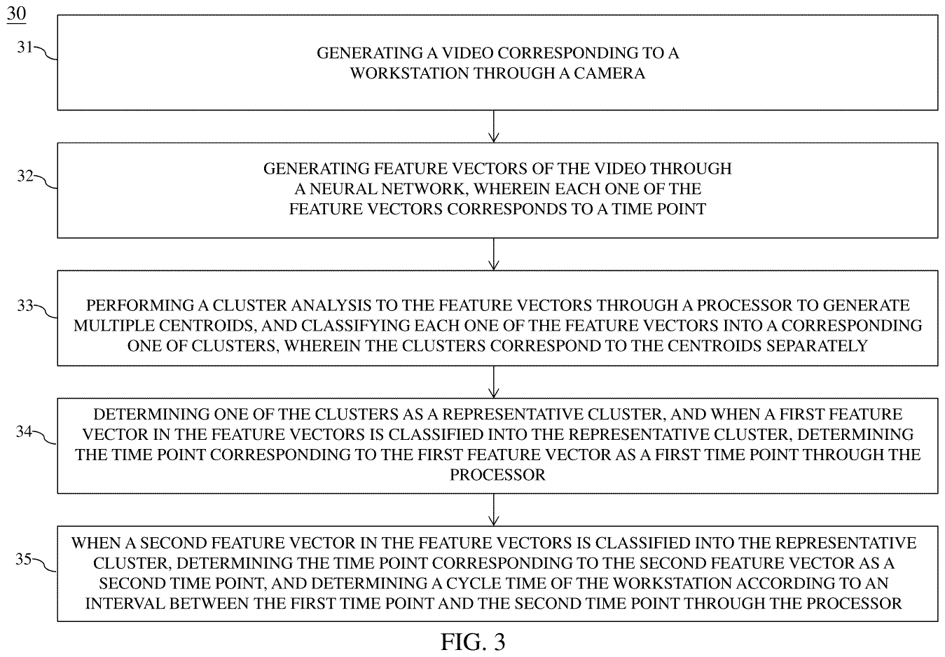

Reference is now made to FIG. 3. FIG. 3 is a flowchart of a method 30, in accordance with some embodiments of the present disclosure. It is understood that additional operations can be provided before, during, and after the processes shown by FIG. 3, and some of the operations described below can be replaced or eliminated, for additional embodiments of the method 30. The method 30 includes operations 31-35 as described below. In some embodiments, the method 30 can be utilized to operate the systems 10 and 20. In some embodiments, the method 30 is implemented by program instructions stored in a non-transitory computer-readable medium (e.g., storage device 120).

Reference is now made to FIGS. 1-3, in operation 31, the camera device 200 generates the video corresponding to the workstation. In some embodiments, multiple camera devices 200 correspond to multiple workstations separately. Each camera device 200 takes a video of the corresponding workstation.

In some embodiments, one camera device 200 may correspond to multiple workstations. The video took by such camera device 200 may include multiple workstations.

In some embodiments, the processor 110 captures the area targeted for the cycle time detection in the video according to the ROI set by the user. In some embodiments, the area corresponding to a target workstation is captured from the video including multiple workstations through utilizing of the ROI.

In some embodiments, multiple coordinates are set by the user to indicate the ROI. For example, the area bounded by the coordinates in a frame of the video refers to the ROI.

In some embodiments, the processor 110 extracts the ROI in each frame of the video to generate a processed video that includes only the ROI. Specifically, the processed video is a video that consists of multiple ROIs corresponding to different time points.

In operation 32, the processor 110 takes a video corresponding to a workstation or the described processed video as the input to the model M to generate feature vectors L. According to some embodiments, these feature vectors L correspond to different time points separately.

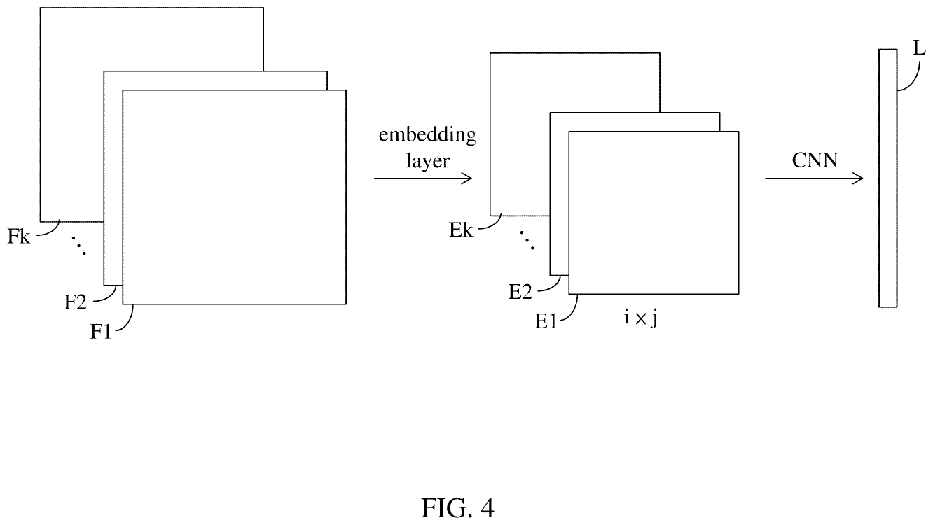

Reference is now made to FIGS. 1-4. FIG. 4 depicts an example of generation of the feature vector L, in accordance with various embodiments of the present disclosure. In some embodiments, the neural network structure of the model M includes an embedding layer and a CNN. In some embodiments, the CNN of the model M is a three dimensional convolutional neural network (3D CNN).

In some embodiments, the processor 110 extracts k consecutive frames F1 to Fk in the video or the processed video as the input to the model M, in which k is a positive integer. The embedding layer receives these k frames and generates k matrices with a dimension of i×j, in which i and j are positive integers.

Then, the CNN receives the k matrices as its input and generates the feature vector L as its output.

In some embodiment, i is 64, j is 512 and a length of the feature vector L is 512.

In some embodiments, the processor 110 sequentially extracts multiple sets of k consecutive frames F1 to Fk from the video or the processed video in chronological order as multiple inputs to the model M. For example, processor 110 first extracts k frames F1 to Fk between the first and second time points and inputs them into the model M, then extracts k frames F1 to Fk between the second and third time points and inputs them into the model M, and so on.

According to some embodiments, each set of k consecutive frames F1 to Fk corresponds to a time point. For example, when a frame F1 is a frame at a first time point, the set of k consecutive frames corresponding to this frame F1 corresponds to the first time point. In some embodiments, the processor 110 records the time point that each set of k consecutive frames F1 to Fk corresponds to.

In some embodiments, since the duration of each set of k consecutive frames F1 to Fk has the same length, processor 110 determines the corresponding time point of each set of k consecutive frames F1 to Fk based on the start time of the video or the processed video and the chronological order of these consecutive frames.

For example, the start time of the video or the processed video is nine o'clock, and a duration of a set of k consecutive frames F1 to Fk is one minute. The processor 110 can determine that the first set of k consecutive frames F1 to Fk corresponds to nine o'clock, the first set of k consecutive frames F1 to Fk corresponds to one minute past nine o'clock, and so on.

In some embodiments, the storage device stores the vector L corresponding to each set of k consecutive frames F1 to Fk. For example, the model M receives a first set of k consecutive frames F1 to Fk corresponding to a first time point to generate a first feature vector L. The storage device 120 records that the first feature vector L corresponds to the first time point and/or the first set of k consecutive frames F1 to Fk.

In some embodiments, the storage device 120 stores the feature vectors L outputted by the model M sequentially. In some embodiments, the storage device 120 records the generated order of the feature vectors L.

In some embodiments, the processor 110 determines the set of k consecutive frames F1 to Fk and the time point corresponding to a feature vectors L according to its generated order. For example, the processor 110 determines that the first feature vector L corresponds to the first set of k consecutive frames F1 to Fk and the first time point.

In operation 33, the processor 110 performs a cluster analysis (e.g., a k-means algorithm) of the feature vectors L. The processor 110 performs the cluster analysis to the feature vectors L within a time window. For example, a time window has a length of ten minutes, and the processor 110 performs the cluster analysis to the feature vectors L generated within the period of 9:00 to 9:10.

In some embodiments, a time window includes four or five cycle times.

In addition, each time window has a corresponding time point. For example, the processor 110 determines the start time of a time window as the corresponding time point of the time window.

According to some embodiments, the processor 110 performs the cluster analysis to generate multiple centroids, and classifies the feature vectors L according to the centroids. In some embodiments, the centroids are vectors.

For example, a time window corresponds to a time point t, and the processor 110 performs the cluster analysis to the feature vectors L within this time window to generate n centroids C1 to Cn, in which n is a positive integer. In some embodiments, the centroids C1 to Cn have vector lengths sorted from largest to smallest.

Then, the processor 110 classifies the feature vectors L in the time window into n clusters. Each cluster corresponds to one of the centroids C1 to Cn.

In some embodiments, during the cluster analysis, the processor 110 determines the distances between the feature vector L and the centroids C1 to Cn, and classifies the feature vector L according to the centroid corresponding to the smallest distance. For example, the processor 110 determines that the distance between the feature vector L and the centroid C1 is the smallest among the distances between feature vector L and the centroid C1 to Cn separately. The processor 110 accordingly determines that the feature vector L belongs to the cluster corresponding to the centroid C1.

Specifically, multiple feature vectors L classified into one cluster indicates that the sets of k consecutive frames F1 to Fk corresponding to these feature vectors L include similar actions. Alternatively speaking, the n clusters correspond to n different set of actions.

In operation 34, the processor 110 determines that the greatest one among the centroids C1 to Cn in the time window of the time point t as a representative centroid Cm. In some embodiments, the greatest centroid is the centroid having the largest vector length. The processor 110 determines the cluster corresponding to the representative centroid Cm as a representative cluster, in which the corresponding set of actions is a representative set of actions.

When the feature vector L is classified into the representative cluster, it can be inferred that the set of k consecutive frames F1 to Fk corresponding to the feature vector L includes the representative set of actions.

In some embodiments, when the feature vector is classified into the representative cluster, the processor determines the time point corresponding to the feature vector L as the time point of the representative set of actions. In some embodiments, the storage device 120 records the time point corresponding to this feature vector L. In some embodiments, the storage device 120 records the representative set of actions corresponding to this time point.

In operation 35, when the processor 110 determines again that a feature vector L belongs to the representative cluster, the processor 110 marks the time point corresponding to this feature vector L as the time point corresponding to the representative set of actions. The processor 110 generates a cycle time based on the time difference between the most recent time point corresponding to the representative set of actions and the current time point corresponding to the representative set of actions.

For example, the processor 110 determines that the feature vector L at 9:05 belongs to the representative cluster and corresponds to the representative set of actions. Then, the processor 110 determines that the feature vector L at 9:10 also belongs to the representative cluster and corresponds to the representative set of actions. The processor 110 determines a cycle time of five minutes according to the time difference between 9:05 and 9:10.

Specifically, the processor 110 determines that multiple feature vectors L belong to the representative cluster. Then, the processor 110 uses the time interval between two consecutive ones in these feature vectors L as a cycle time. The processor 110 generates multiple cycle times in this manner.

According to some embodiments, the processor 110 performs a break detection to determine whether a time window corresponds to a break time. Specifically, the processor 110 determines a threshold and calculates a standard deviation of the centroids C1 to Cn of the time window. When the standard deviation is smaller than the threshold, it can be inferred that there is little change between frames within the time window, and the processor 110 determines that the time window corresponds to the break time.

In some embodiments, when the processor 110 determines that the time window corresponds the break time, the processor 110 does not perform the representative cluster classification and cycle time determination within the time window.

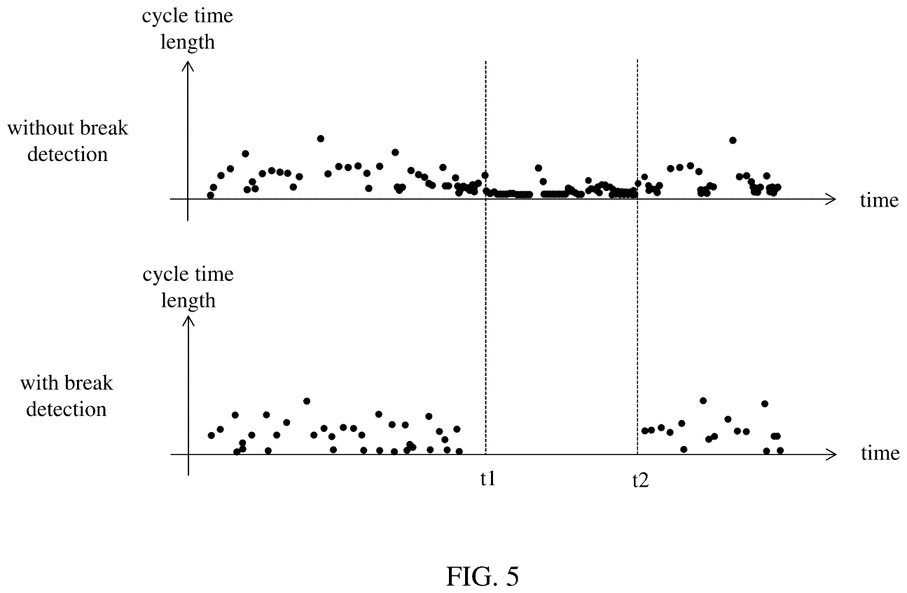

Reference is now made to FIGS. 1-5. FIG. 5 depicts an example of length and distribution of cycle time, in accordance with various embodiments of the present disclosure. The upper portion of FIG. 5 depicts cycle times and their lengths generated by processor 110 at different time points without the break detection. The lower portion of FIG. 5 depicts cycle times and their lengths generated by processor 110 at different time points with the break detection.

In the example of FIG. 5, the period between a time point t1 and a time point t2 is the break time. As shown in FIG. 5, with the break detection, the processor 110 does not generate cycle times between the time point t1 and the time point t2.

In some embodiments, the processor updates the centroids of the current time window according to the centroids of the most recent previous time window. For example, when the current time window corresponds to a time point t, the centroids C1 to Cn of the current time window are referred to as C1t to Cnt. The most recent previous time window corresponds to a time point t-1, the centroids C1 to Cn of the most recent previous time window are referred to as C1t-1 to Cnt-1. The processor 110 updates the centroids C1t to Cnt of the current time window according to the following Equation 1 to generate updated centroids RC1t to RCnt.

$$RCxt = ( RCxt - 1 \times w + Cxt ) / ( w + 1 ) \qquad Equation 1$$

In the Equation 1, x belongs to integers 1 to n. RCxt-1 is the updated centroids of the most recent previous time window. w is a weight and it can be set as arbitrary number. In some embodiments, the weight w is configured to be greater than or equal to 1. In some embodiments, the storage device 120 records the centroids and the updated centroids (e.g., RCxt and RCxt-1). The processor 110 performs the operation of updating the centroids according to the data stored in the storage device 120.

In some embodiments, the processor 110 uses the updated centroids RC1t to RCnt to replace the centroids C1t to Cnt. For example, the processor 110 generates the cycle time through the operations described above but the centroids C1t to Cnt are replaced by the updated centroids RC1t to RCnt.

In some embodiments, the processor 110 increases the weight w over time. For example, during each update of the centroids, processor 110 increments the value of the weight w by 1, in which the weight w corresponding to the time point t-1 is 1, and the weight w corresponding to the time point t is 2. In some embodiments, the storage device 120 records an upper limit value for the weight w. If continuing to increase the weight w would cause it to exceed this upper limit, the processor 110 stops increasing the value of the weight w.

According to some embodiments, the relationship between actions before and after the break time may be weak. In some embodiments, after a long break time, the product type produced at the workstation may be changed. Therefore, in some embodiments, when the current time is determined as the break time, the processor 110 decreases the value of the weight w over time. In some embodiments, when the break time has last longer than a pre-defined length stored in the storage device 120, the processor 110 stops decreasing the value of the weight w. In some embodiments, when the value of the weight is 1, the processor 110 stops decreasing the value of the weight w.

In some embodiments, when the break time ends, the processor 110 continues to increase the value of the weight w over time.

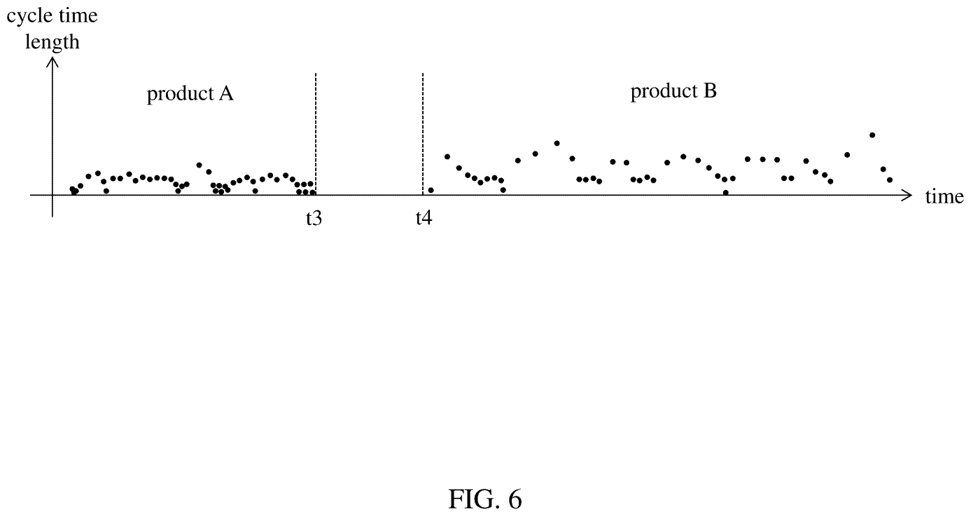

Reference is now made to FIGS. 1-6. FIG. 6 depicts an example of length and distribution of cycle time, in accordance with various embodiments of the present disclosure. According to some embodiments, the systems 10 and 20 are adaptive cycle time detection systems. Specifically, when the product type or manufacturing process in the product line are changed, the systems 10 and 20 are adaptive to different product types and manufacturing processes, and there is no need to terminate or reset the systems 10 and 20.

In some embodiments, the processor 110 determines the product type or manufacturing process corresponding to a time window according to the distribution of lengths of cycle times within the time window. For example, when the distributions of lengths of cycle times of multiple time windows are similar, the processor 110 determines that these time windows correspond to a same product type or manufacturing process. In some embodiments, when the mean values of length corresponding to consecutive time windows separately are similar, the processor 110 determines that these time windows correspond to a same product type or manufacturing process.

As shown in FIG. 6, the processor 110 determines that the time windows before a time point t3 correspond to the same product (e.g., product A) based on the similarity in the distributions or mean values of the cycle time lengths of the time windows. The processor 110 determines that the time windows after a time point t4 correspond to a different product (e.g., product B, which is different from product A) because the distributions or mean values of the cycle time lengths of time windows after the time point t4 differ from those before the time point t3.

In summary, the present disclosure provides system and method for cycle time detection. The system and method updates the current centroids according to the historical centroids so as to utilize data in multiple time windows. As a result, the cycle time detection will be more stable. The proposed system and method perform similarity comparison (cluster analysis) between features extracted through the neural network to determine the end of a cycle. Such determination is not affected by speed of individual actions, thereby improving the accuracy of the cycle time detection. Furthermore, the proposed break detection reduces false alarms and system workload by halting the cycle time detection during break time. Since each detection corresponds to a specific time point, it enables precise detection of when an abnormality (e.g., excessively long cycle time) occurs. Combined with video recordings, this enables accurate determination of the root cause of the anomaly. Compared to some approaches, the proposed system and method use fewer computational resources and offer faster execution speed.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system for cycle time detection, comprising:
a camera device configured to capture a video of a workstation; and
an electronic device comprising:
a storage device configured to store a machine learning model; and
a processor configured to:
perform an inference of the machine learning model to generate a plurality of first feature vectors corresponding to a plurality of first time points in the video separately;
perform a cluster analysis to the first feature vectors to generate a plurality of first centroids, and classify each one of the first feature vectors into a corresponding one of a plurality of clusters, wherein the clusters correspond to the first centroids separately; and
generate a plurality of cycle times according to a plurality of second time points of a plurality of second feature vectors that are classified into a representative cluster, wherein the second feature vectors are among the first feature vectors.

2. The system of claim 1, wherein the processor is further configured to determine whether the first time points correspond to a break time of the workstation according to a standard deviation of the first centroids,
wherein when the first time points are determined to correspond to the break time, the processor stops generating the cycle times.

3. The system of claim 1, wherein the processor is further configured to adjust the first centroids according to a plurality of second centroids and a weight stored in the storage device.

4. The system of claim 3, wherein the processor is further configured to increase a value of the weight over time.

5. The system of claim 4, wherein the processor is further configured to decrease the value of the weight when the first time points are determined as a break time.

6. A method for cycle time detection, comprising:
generating a video corresponding to a workstation through a camera;
generating a plurality of feature vectors of the video through a neural network, wherein each one of the feature vectors corresponds to a time point;
performing a cluster analysis to the feature vectors through a processor to generate multiple centroids, and classifying each one of the feature vectors into a corresponding one of a plurality of clusters, wherein the clusters correspond to the centroids separately;
determining one of the clusters as a representative cluster, and when a first feature vector in the feature vectors is classified into the representative cluster, determining the time point corresponding to the first feature vector as a first time point through the processor; and
when a second feature vector in the feature vectors is classified into the representative cluster, determining the time point corresponding to the second feature vector as a second time point, and determining a cycle time of the workstation according to an interval between the first time point and the second time point through the processor.

7. The method of claim 6, further comprising:
determining whether the time points belong to a break time of the workstation according to whether a standard deviation of the centroids is smaller than a threshold.

8. The method of claim 6, further comprising:
generating a plurality of multiplications between a plurality of historical centroids and a weight; and
updating the centroids according to a plurality of additions between the multiplications and the centroids.

9. The method of claim 8, further comprising:
decreasing a value of the weight when the time points are determined belonging to a break time.

10. The method of claim 9, further comprising:
stopping decreasing the value of the weight when the value of the weight is one.
